(19) United States
(12) Patent Application Publication
(10) Pub. No.: US 2011/0273372 A1
(43) Pub. Date: Nov. 10, 2011

(54) MOBILE DEVICE WITH UNIQUE FEATURES

(76) Inventor: Elsid Aliaj, Fort Lee, NJ (US)

(21) Appl. No.: 13/103,995

(22) Filed: May 9, 2011

Related U.S. Application Data
(60) Provisional application No. 61/332,788, filed on May 9, 2010.

(51) Int. Cl. G06F 3/02

(52) U.S. Cl. 345/168

(57) ABSTRACT

A mobile device having a translucent screen that is the size of the mobile device and a full size keyboard having a left side member, a center member, and a right side member. When the keyboard is open, the center member is slidably attached to the front of the mobile device screen where the left member is slidably or foldably attached to the left side of the center member and the right member is slidably or foldably attached to the right side of the center member. When the keyboard is not in use, it is stored under the screen of the mobile device with the left member located under the center member and the right member located over the center member. To use the keyboard, a user slides the folded keyboard out from beneath the screen and opens the keyboard to its full size by sliding or unfolding the left and right side members about the center member.

### REFERENCE TO RELATED APPLICATIONS

This patent application claims the benefit of U.S. Provisional Application No. 61/332,788 filed on May 9, 2010, the disclosure of which is incorporated herein by reference in its entirety.

### BACKGROUND OF THE INVENTION

1. Field of the Invention

The present invention relates to a mobile device such as a smart phone, mp3 player, laptop, tablet, or mobile computing system having a translucent screen with an image recording device embedded therein, a translucent screen which is the full size of the mobile device, or a holographic screen which shoots out and floats in mid air, which can also be touch sensitive. The mobile device also has joysticks for games which may be located on a retractable keyboard that slides below the screen and a cover that covers and protects all parts on the mobile device. The keyboard has keys arranged in the standard pattern where the keyboard can be folded into three sections for storage in an area below the screen.

2. Description of Related Art

A mobile device with a folding keyboard is known in the prior art. More specifically, by way of example, U.S. Pat. No. 7,489,301 to Chen, et al. discloses a keyboard where the keys are split into a left side section and a right side section. The left side section is oriented at least partially above the right side section, or the right side section is oriented at least partially above the left side section.

U.S. Pat. No. 7,030,323 to Lahr discloses a keyboard having an expandable and compressible housing which supports a plurality of elastic belts. The key switch assemblies are fastened to the elastic belt. When the keyboard housing is expanded, the elastic belts are stretched, and the distance between the keys is increased. The keytops can be of variable size so that upon expansion, they increase in size.

U.S. Pat. No. 6,867,965 to Khoo discloses a first portable computing device containing a first portion of a full-size conventional QWERTY keyboard and a second portable computing device containing a second portion of the full-size keyboard where the first portion and the second portion together comprise the keys of the full-size keyboard. A network link is established that couples the first portable computing device to the second portable computing device.

U.S. Pat. No. 6,714,403 to Furuki, et al. discloses a keyboard unit which is divided into a first keyboard unit and a second keyboard unit so as to be foldable where the first keyboard unit is pivotably supported by the second keyboard unit so as to pivot about a position slightly inside from an end of a coupling side of the second keyboard unit.

U.S. Pat. No. 6,628,961 to Ho, et al. discloses a microprocessor and a random access memory which is included in the keyboard where, after sending an interrupt command from the handset to the keyboard, whether a key is pressed or not is determined by the microprocessor and the key value is stored in its own random access memory.

U.S. Pat. No. 6,266,234 to Leman discloses a keyboard which includes first and second portions that are removably coupled to each other. The second portion can be removably coupled to one part of the first portion to block access to input keys of the first portion, and can be removably attached to another part of the first portion to allow access to the input keys to form a full-size keyboard.

U.S. Pat. No. 6,174,097 to Daniel discloses a keyboard that is foldable about three substantially parallel axes between the deployed and collapsed configurations where the keyboard has four rigid subframes for supporting keys.

### SUMMARY OF THE INVENTION

In an exemplary embodiment of the present invention, there is disclosed a mobile device comprising:
a translucent screen with a size that is the full size of the mobile device, and
a full size keyboard having a left side member, a center member and a right side member;
wherein, when the keyboard is open and being used, the center member is slidably attached to the mobile device screen and located in front of the screen of the mobile device, the left member is slidably or foldably attached to the left side of the center member, and the right member is slidably or foldably attached to the right side of the center member; or
wherein, when the keyboard is not in use it is stored under the screen of the mobile device with the left member located under the center member and the right member is located over the center member;
wherein, to use the keyboard, a user slides the folded keyboard out from beneath the screen and opens the keyboard to its full size by sliding or unfolding the left and right side members about the center member.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a view of a mobile device with a standard keyboard of reduced size which has been pulled out from its storage area located under the screen of the mobile device;

FIG. 2 is a view of a mobile device with no keyboard and ONLY joysticks for playing games; and

FIG. 3 is a view of a mobile device with a full size keyboard retracted from its storage area, with a touch holographic screen where the image floats in air.

### DESCRIPTION OF THE PREFERRED EMBODIMENT

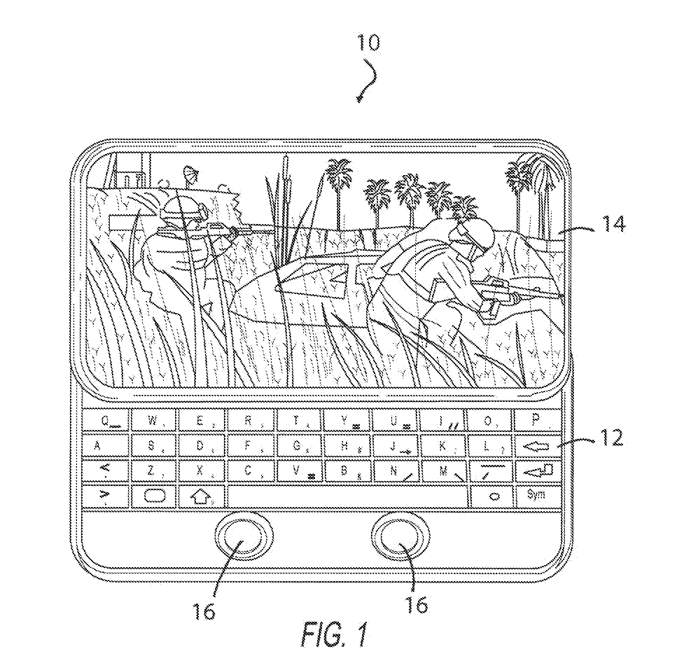

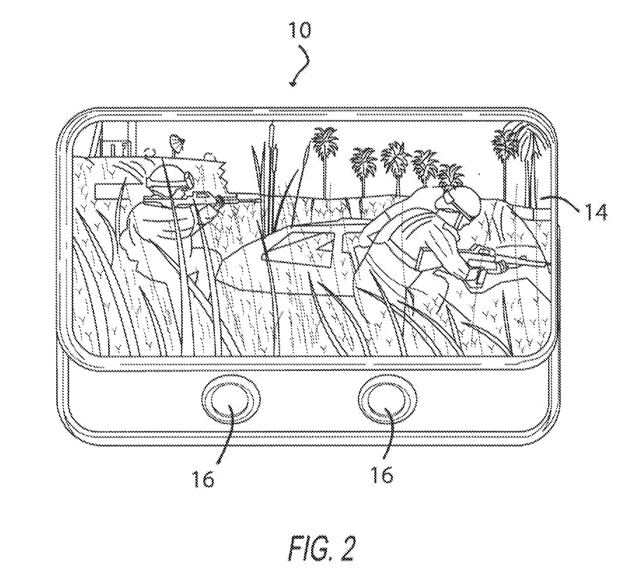

Referring to FIGS. 1, 2 and 3, there is disclosed a front view of a mobile device 10 with a standard keyboard 12 of reduced size which has been pulled out from its storage area located under the screen 14 of the mobile device; a mobile device with joysticks for playing games an absent a keyboard; and a mobile device with a full size keyboard pulled out from its storage area were the screen is a touch holographic screen which displays an image that floats in the air.

In an embodiment of the present invention, the hardware features include a translucent screen with a size that is the full size of the mobile device, a screen that is a mid air floating holographic screen, and joy sticks 16 that may be used when playing games. Also the device may have a regular screen where the translucent screen may only be a small part of the screen, and only if the design includes putting a camera behind it is used. If the camera is not being used, a regular amoled, or super amoled, or any kind of screen may be used. Further features include a mobile device having a capacitive touch screen, a screen on which a user can draw and/or write on, and a screen that has the ability to be tilted.

In an embodiment of the invention the mobile device has an HDMI slot, an SD card slot, a 3.5 mm jack and a USB drive that is retractable and/or removable.

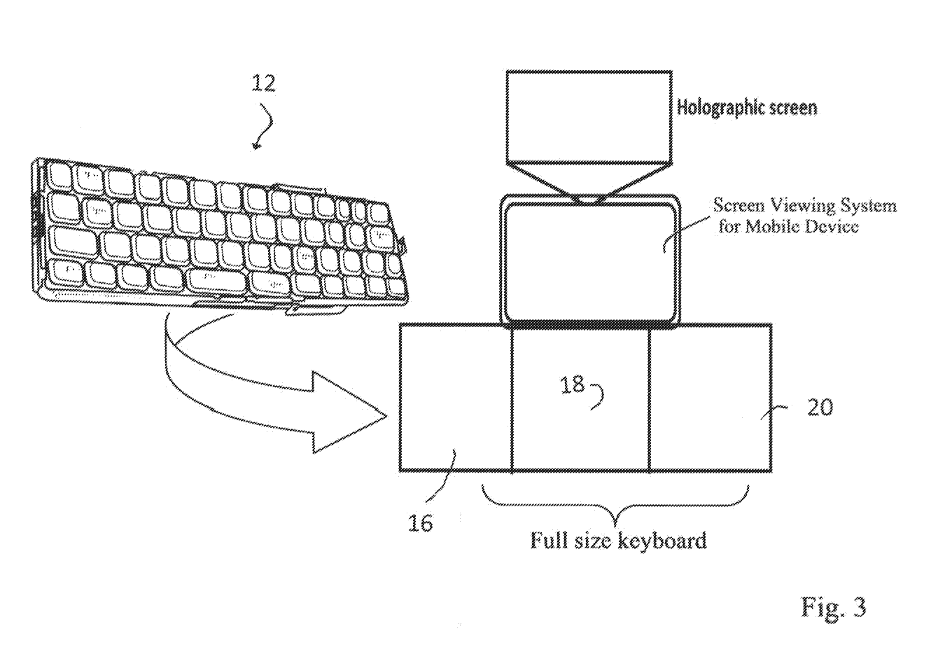

Looking at FIG. 3, the keyboard 12, which is a full size keyboard, consists of three members, a left member 16, a center member 18 and a right member 20. When the keyboard is open and being used, the center member is slidably attached to the mobile device screen, the left member is slidably or foldably attached to the left side of the center member, and the right member is slidably or foldably attached to the right side of the center member. When the keyboard is not in use it is stored under the screen of the mobile device. In its stored condition the left member is located under the center member and the right member is located over the center member To open the keyboard for use, a user simply slides the folded keyboard out from beneath the screen and opens the keyboard to its full size by either sliding or unfolding the left and right side members about the center member.

In an embodiment of the invention the mobile device has a translucent screen with an image recording device embedded therein. The image recording device, such as a camera can be located on the obverse side, the reverse side, or on each side of the mobile device.

In another embodiment of the invention a touch control panel may located on the obverse side of the mobile device.

In another embodiment of the invention a touch control panel may be located on the reverse side of the mobile device.

In another embodiment of the invention the mobile device has a touch sensitive area without a keyboard.

In another embodiment of the invention the mobile device has joy sticks without a keyboard for typing letters or numbers.

In another embodiment of the invention there is a mobile device with a wide screen and a standard type and size keyboard or a standard type of keyboard of reduced size which slides in and out from beneath the screen.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A mobile device comprising:
a translucent screen with a size that is the full size of the mobile device, and
a full size keyboard having a left side member, a center member and a right side member;
wherein, when the keyboard is open and being used, the center member is slidably attached to the mobile device screen and located in front of the screen of the mobile device, the left member is slidably or foldably attached to the left side of the center member, and the right member is slidably or foldably attached to the right side of the center member; or
wherein, when the keyboard is not in use it is stored under the screen of the mobile device with the left member located under the center member and the right member is located over the center member;
wherein, to use the keyboard, a user slides the folded keyboard out from beneath the screen and opens the keyboard to its full size by sliding or unfolding the left and right side members about the center member.

2. The mobile device of claim 1 wherein the screen displays a holographic image which floats in mid air. which can also be touch sensitive.

3. The mobile device of claim 1 wherein the screen is a touch sensitive screen.

4. The mobile device of claim 1 wherein the screen is an amoled screen.

5. The mobile device of claim 1 wherein the screen is a super amoled screen.

6. The mobile device of claim 1 wherein the screen is a capacitive touch screen.

7. The mobile device of claim 1 wherein a user can draw or write on the screen.

8. The mobile device of claim 1 wherein the screen can be tilted.

9. The mobile device of claim 1 wherein the device includes an HDMI slot.

10. The mobile device of claim 1 wherein the device includes an SD card slot.

11. The mobile device of claim 1 wherein the device includes a 3.5 m jack.

12. The mobile device of claim 1 wherein the device includes a USB drive that is retractable or removable.
